(19) United States
(12) Patent Application Publication
(10) Pub. No.: US 2023/0350642 A1
(43) Pub. Date: Nov. 2, 2023

(54) FIELD SPACE DATA NORMALIZATION PROCESSING METHOD APPLICABLE TO GBP ALGORITHM

(71) Applicant: NATIONAL CENTRAL UNIVERSITY, Taoyuan City (TW)

(72) Inventors: Chih-Wei HUANG, Taoyuan City (TW); Jann-Long CHERN, Taoyuan City (TW); Han-Chun WANG, Taoyuan City (TW); Yu-Siang FENG, Taoyuan City (TW); Jian-Yu CHEN, Taoyuan City (TW); Yin-Qiao ZHANG, Taoyuan City (TW); Ching-Cherng SUN, Taoyuan City (TW)

(21) Appl. No.: 17/838,816

(22) Filed: Jun. 13, 2022

(30) Foreign Application Priority Data
Apr. 29, 2022 (TW) 111116523

(51) Int. Cl. G06F 7/78

(52) U.S. Cl. CPC G06F 7/78

(57) ABSTRACT

Provided is a field space data normalization processing method applicable to GBP algorithm, including the steps of: performing vector matrix transformation, by inputting first vector data and transforming it into a first matrix expression; performing first matrix transformation, by transforming the first matrix expression into a second matrix expression; providing a means of normalization; performing normalization and third matrix transformation, by performing data normalization and transformation on the second matrix expression to obtain a third matrix expression; transforming a third matrix and outputting second vector data, by transforming the third matrix expression into a fourth matrix expression and then transforming it into second vector data and outputting it. Therefore, normalization of camera pose data in SLAM is achieved.

### BACKGROUND OF THE INVENTION

### 1. Technical Field

The present disclosure relates to field space data normalization processing methods applicable to GBP (Gaussian Belief Propagation) algorithm and, more particularly, to a field space data normalization processing method applicable to GBP algorithm for simultaneous localization and mapping (SLAM) related to machine learning.

### 2. Description of Related Art

SLAM aims to enable robots to achieve localization, mapping, and navigation in unknown surroundings. SLAM technology is currently widely applied to robots, unmanned aerial vehicles (UAVs), self-driving cars, AR and VR to achieve autonomous localization, mapping, navigation of machines with sensors. Existing mainstream SLAM technology application falls under two categories: laser SLAM for use in mapping and navigation using laser radar, and vision SLAM based on monocular/binocular camera vision mapping and navigation.

When it comes to developing vision SLAM, bundle adjustment is the last step of nearly all the algorithms which use feature points in 3D model reconstruction and the best solution for optimization of 3D models, camera poses, camera matrix, and deformation parameters.

The concepts of neural networks are incorporated into GBP (Gaussian Belief Propagation) algorithm to compute bundle adjustment in SLAM. Initial field space data value varies from data and processing technique to data and processing technique; thus, neural network models are extremely unstable during training, and computation indicates that abnormal values cause a training failure. Furthermore, when initial field space data is used to train neural networks, deviations of overlearned data lead to low generalization of models

Therefore, data preprocessing is an important step in machine learning and usually involves performing normalization on data. However, SLAM technology has a drawback: camera pose data exists in the space of mathematically defined SE(3)-Special Euclidean Group, and SE(3) is unable to perform normalization on data directly.

Referring to FIG. 1, a simulation test is conducted to study the fitting capability of a model on a training set in the presence of the loss of the training data, i.e., train loss, when unnormalized data is used to carry out a neural network model training and study the fitting capability, i.e., generalization capability, of a model on unseen data because of the valid loss on a validation set. Referring to FIG. 1, during the aforesaid validation process performed on unnormalized data, NaN (Not a Number) occurs as the model has been trained to attain the 14^{th} epoch, and thus the model cannot effectively undergo training and validation.

### BRIEF SUMMARY OF THE INVENTION

The present disclosure provides a field space data normalization processing method applicable to GBP algorithm to overcome drawbacks of machine learning, namely, the initial field space data value is incorrect, and model generalization is low.

The present disclosure provides a field space data normalization processing method applicable to GBP algorithm and adapted to perform on a computer the steps of: performing vector matrix transformation by inputting a first vector data with a first computation module and transforming it into a first matrix expression

$$[ \begin{matrix}Ω & P \\ 0 & 0\end{matrix} ]$$

in a se(3) corresponding to SE(3), where

$$Ω = [ \begin{matrix}0 & - {ω}_{3} & {ω}_{2} \\ {ω}_{1} & 0 & {ω}_{1} \\ {ω}_{2} & - {ω}_{3} & 0\end{matrix} ] , and P = [ \begin{matrix}{ρ}_{1} \\ {ρ}_{2} \\ {ρ}_{3}\end{matrix} ] ;$$

performing first matrix transformation by transforming, in a second computation module, a first matrix expression

$$[ \begin{matrix}Ω & P \\ 0 & 0\end{matrix} ]$$

into a second matrix expression

$$[ \begin{matrix}R & {T}^{′} \\ 0 & 1\end{matrix} ]$$

in SE(3); providing a means of normalization, comprising providing a data normalization algorithm

$${X}_{nom} = \frac{X - μ}{{X}_{max} - {X}_{min}} ∈ [ - 1 , 1 ] ,$$

where X denotes unnormalized source data, μ denotes the mean of unnormalized source data X, Xmax and Xmin denote the maximum and minimum of unnormalized source data X, respectively, Xnom denotes normalized data; performing normalization and third matrix transformation by performing data normalization on the second matrix expression

$$[ \begin{matrix}R & {T}^{′} \\ 0 & 1\end{matrix} ]$$

with the data normalization algorithm and transforming it into a third matrix expression

$$[ \begin{matrix}R & T \\ 0 & 1\end{matrix} ] ,$$

where

$$\tilde{T} = \frac{T - R μ}{S} ,$$

S=Xₘₐₓ−Xₘᵢₙ, and S denotes range; and performing normalization by performing data normalization on the second matrix expression

$$[ \begin{matrix}R & T \\ 0 & 1\end{matrix} ]$$

in a third computation module; performing second matrix transformation by transforming, in a fourth computation module, data-normalized second matrix expression

$$[ \begin{matrix}R & T \\ 0 & 1\end{matrix} ]$$

into a third matrix expression

$$[ \begin{matrix}R & T \\ 0 & 1\end{matrix} ]$$

in SE(3), where

$$\tilde{T} = \frac{T - R μ}{S} ,$$

S=Xₘₐₓ−Xₘᵢₙ, μ is the mean of X; and transforming third matrix and outputting second vector data by transforming, in a fifth computation module, the third matrix expression

$$[ \begin{matrix}R & T \\ 0 & 1\end{matrix} ]$$

into a fourth matrix expression

$$[ \begin{matrix}Ω & P \\ 0 & 0\end{matrix} ]$$

in se(3) corresponding to SE(3), and then transforming it into a second vector data and outputting it, thereby finalizing normalization of the first vector data.

The implementation of the present disclosure at least achieves inventive benefits as follows:
1. Achieve the objective of normalization of camera pose data in SLAM.
2. Stabilize an initial data value to allow it to fall within a specific range, allowing a model to be trained smoothly.
3. Enhance generalization capability of a model to enable its application in more scenes.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein:

FIG. 1 (PRIOR ART) enumerates valid loss and train loss of model training carried out with unnormalized data;

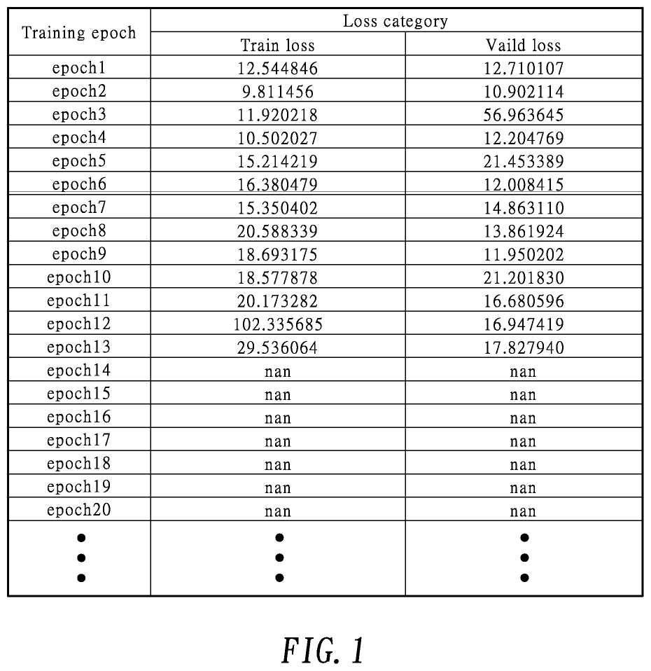

FIG. 2 illustrates the process flow of field space data normalization processing method applicable to GBP algorithm according to an embodiment of the present disclosure; and

FIG. 3 is a block diagram of the field space data normalization processing method applicable to GBP algorithm according to an embodiment of the present disclosure.

### DETAILED DESCRIPTION OF THE INVENTION

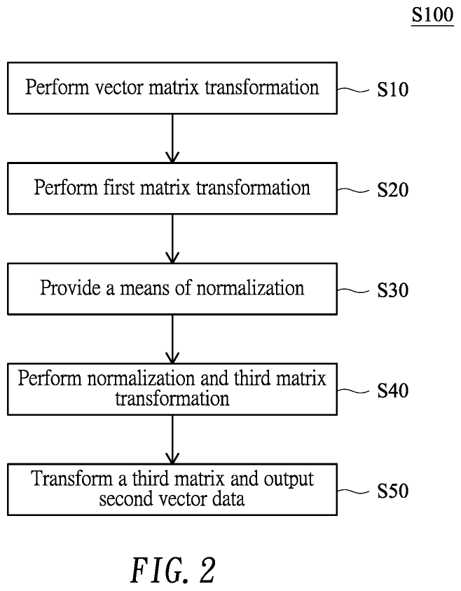

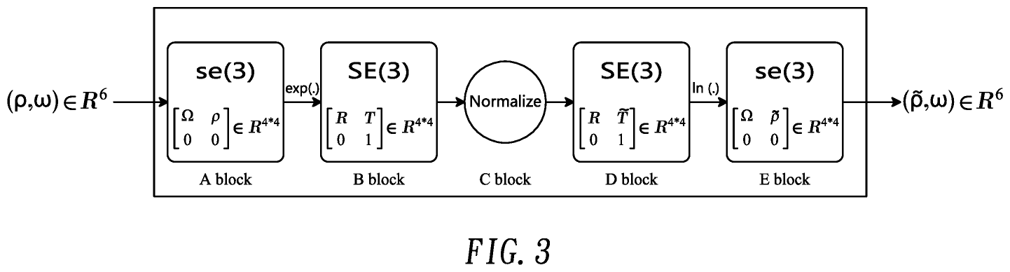

Referring to FIG. 2 and FIG. 3, this embodiment provides a field space data normalization processing method applicable to GBP algorithm S100. The method entails carrying out, on a computer, the steps of: performing vector matrix transformation S10; performing first matrix transformation S20; providing a means of normalization S30; performing normalization and third matrix transformation S40; and transforming a third matrix and outputting second vector data S50.

Lie groups are continuous and smooth; they are groups and manifolds. Intuitively, a rigid body is able to move continuously within a space, and thus both SO(3) and SE (3) are Lie groups. SO(3) is a special orthogonal group, whereas SE(3) is a special Euclidean group. A three-dimensional rotational matrix constitutes a special orthogonal group SO(3), whereas a transformation matrix constitutes a special Euclidean group SE(3). Both SO(3) and SE(3) can work with well-defined multiplication rather than addition and thus are hardly useful in taking limits and taking derivatives.

A Lie algebra corresponds to a Lie group and lies in a vector space. They are commonly abbreviated to so(3) and se(3). In fact, a Lie algebra is a tangent space at an identity element of a Lie group. A tangent space itself is a vector space, and thus the tangent space can be defined with a good addition computation. Therefore, characteristics of a Lie group can be evaluated with a corresponding Lie algebra (i.e., tangent space). For the sake of illustration, se(3) corresponding to SE(3), which the SE(3) in this embodiment corresponds to, is abbreviated to “se(3) corresponding to SE(3).”

The step of performing vector matrix transformation S10 is explained below. With the first computation module A block, a first vector data, for example, (ρ,ω)=(ρ₁, ρ₂, ρ₃, ω₁, ω₂, ω₃)∈R⁶, is inputted, and then the first vector data is transformed into a first matrix expression

$$[ \begin{matrix}Ω & P \\ 0 & 0\end{matrix} ]$$

in a se(3) corresponding to SE(3), where

$$Ω = [ \begin{matrix}0 & - {ω}_{3} & {ω}_{2} \\ {ω}_{1} & 0 & {ω}_{1} \\ {ω}_{2} & - {ω}_{3} & 0\end{matrix} ] , and P = [ \begin{matrix}{ρ}_{1} \\ {ρ}_{2} \\ {ρ}_{3}\end{matrix} ] .$$

Therefore, R⁶ space includes therein: the leading three dimensions ρ₁, ρ₂, ρ₃ being translational, and the trailing three dimensions ω₁, ω₂, ω₃ being rotational. Finally, a six-dimensional vector is transformed into a four-dimensional matrix.

The step of performing first matrix transformation S20 involves performing exponential mapping from “se(3) corresponding to SE(3)” to “SE(3),” with details being explained below. In a second computation module B block, a first matrix expression

$$[ \begin{matrix}Ω & P \\ 0 & 0\end{matrix} ]$$

in se(3) corresponding to SE(3) in a first computation module A block is transformed with, for example, an exponential function exp(.), into a second matrix expression

$$[ \begin{matrix}R & T \\ 0 & 1\end{matrix} ]$$

in SE(3). In short, the first matrix transformation is carried out with, for example, an exponential function exp(.).

The step of providing a means of normalization S30 is explained below. A third computation module C block is provided with a data normalization algorithm, for example, min-max normalization algorithm:

, where X denotes unnormalized source data, and μ denotes the

$${X}_{nom} = \frac{X - μ}{{X}_{max} - {X}_{min}} ∈ [ - 1 , 1 ]$$

mean of unnormalized source data X, allowing the data to be restricted to the range [−1, 1] and to have the mean equal to 0, where Xmax and Xmin denote the maximum and minimum of unnormalized source data X, respectively, and Xnom denotes normalized data.

The step of performing normalization and third matrix transformation S40 is explained below. In a fourth computation module D block, the second matrix expression

$$[ \begin{matrix}R & T \\ 0 & 1\end{matrix} ]$$

in SE(3) undergoes data normalization with a data normalization algorithm of the third computation module C block and transformation to obtain a third matrix expression

$$[ \begin{matrix}R & T \\ 0 & 1\end{matrix} ] ,$$

where

$$\tilde{T} = \frac{T - R μ}{S} ,$$

S=Xₘₐ−Xₘᵢₙ, and S denotes a range.

The step of transforming a third matrix and outputting a second vector data S50 is explained below. In the fifth computation module E block, the normalized third matrix expression

$$[ \begin{matrix}R & T \\ 0 & 1\end{matrix} ]$$

in SE(3) of the fourth computation module D block is transformed back to a fourth matrix expression

$$[ \begin{matrix}Ω & P \\ 0 & 0\end{matrix} ]$$

in se(3) corresponding to SE(3) to undergo the third matrix transformation with, for example, a logarithmic function ln(.).

The step of outputting second vector data is explained below. In the fifth computation module (E block), the fourth matrix expression

$$[ \begin{matrix}Ω & P \\ 0 & 0\end{matrix} ]$$

is transformed once again into a second vector data to be outputted, where the second vector data, for example, is expressed by (\tilde{ρ}, ω)=( [symbol] , [symbol] , [symbol] , ω₁, ω₂, ω₃), thereby finalizing the normalization of the first vector data.

To prove that the present disclosure demonstrates significant inventiveness, both the data normalized in this embodiment and the data normalized according to the prior art undergo train loss simulation analysis and comparison to yield the results shown in Table 1. As shown in Table 1, the neural network model training carried out with the normalized data in this embodiment can attain full completion, but the neural network model training carried out with conventional unnormalized data ends up with NaN at the 20th epoch or thereafter and thus prevents the model from being fully, effectively trained and validated.

TABLE 1

| | Training epochs | | | |
|---|---|---|---|---|
| | Train loss at | Train loss at | Train loss at | |
| Training data | the first | the 10th | the 20th | Final |
| category | epoch | epoch | epoch | loss |
| Normalized data | 0.1 | 0.028 | 0.021 | 0.020085 |
| Unnormalized | 12.54 | 18.57 | NaN | NaN |
| data | | | | |

The above description is only the preferred embodiments of the present invention and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A field space data normalization processing method applicable to GBP algorithm and adapted to perform on a computer the steps of:
performing vector matrix transformation by inputting a first vector data with a first computation module and transforming it into a first matrix expression
$$[ \begin{matrix}Ω & P \\ 0 & 0\end{matrix} ]$$
in a se(3) corresponding to SE(3), where
$$Ω = [ \begin{matrix}0 & - {ω}_{2} & {ω}_{2} \\ {ω}_{1} & 0 & {ω}_{1} \\ {ω}_{2} & - {ω}_{2} & 0\end{matrix} ]$$
and performing first matrix transformation on the
$$P = [ \begin{matrix}{ρ}_{1} \\ {ρ}_{2} \\ {ρ}_{3}\end{matrix} ]$$
by transforming, in a second computation module, the first matrix expression
$$[ \begin{matrix}Ω & P \\ 0 & 0\end{matrix} ]$$
into a second matrix expression
$$[ \begin{matrix}R & T \\ 0 & 1\end{matrix} ]$$
in SE(3);
providing a means of normalization, comprising providing a data normalization algorithm
$${X}_{nom} = \frac{X - μ}{{X}_{max} - {X}_{min}} ∈ [ - 1 , 1 ] ,$$
where X denotes unnormalized source data, μ denotes the mean of the unnormalized source data X, Xmax and the Xmin denote the maximum and minimum in the unnormalized source data X, respectively, and Xnom denotes normalized data;
performing normalization and third matrix transformation by performing data normalization on the second matrix expression
$$[ \begin{matrix}R & T \\ 0 & 1\end{matrix} ]$$
with the data normalization algorithm and transforming it into a third matrix expression
$$[ \begin{matrix}R & T \\ 0 & 1\end{matrix} ] ,$$
where
$$\tilde{T} = \frac{T - R μ}{S} ,$$
S=Xₘₐₓ−Xₘᵢₙ, and S denotes range; and
transforming third matrix and outputting second vector data S50 by transforming, in a fifth computation module, the third matrix expression
$$[ \begin{matrix}R & T \\ 0 & 1\end{matrix} ]$$
into a fourth matrix expression
$$[ \begin{matrix}Ω & P \\ 0 & 0\end{matrix} ]$$
in the se(3) corresponding to SE(3) and then transforming it into a second vector data and outputting it, thereby finalizing normalization of the first vector data.

2. The field space data normalization processing method of claim 1, wherein the first vector data is expressed by (ρ, ω)=(ρ₁, ρ₂, ρ₃, ω₁, ω₂, ω₃)∈R⁶.

3. The field space data normalization processing method of claim 1, wherein the performing first matrix transformation requires an exponential function exp(.).

4. The field space data normalization processing method of claim 1, wherein the performing third matrix transformation requires a logarithmic function ln(.).

5. The field space data normalization processing method of claim 1, wherein the second vector data is expressed by (\tilde{ρ}, ω)=( [symbol] , [symbol] , [symbol] , ω₁, ω₂, ω₃).
